(19) United States
(12) Patent Application Publication
(10) Pub. No.: US 2022/0206431 A1
(43) Pub. Date: Jun. 30, 2022

(54) DRAWER STRUCTURE FOR MOUNTING DEVELOPMENT CARTRIDGE IN IMAGE FORMING APPARATUS

(71) Applicant: Hewlett-Packard Development Company, L.P., Spring, TX (US)

(72) Inventors: Wontaek Kim, Pangyo (KR); Younghoon Kim, Pangyo (KR)

(73) Assignee: Hewlett-Packard Development Company, L.P., Spring, TX (US)

(21) Appl. No.: 17/311,052

(22) PCT Filed: Feb. 13, 2020
(86) PCT No.: PCT/US2020/018090

§ 371 Date: Jun. 4, 2021

(30) Foreign Application Priority Data
Aug. 26, 2019 (KR) 10-2019-0104771

(51) Int. Cl. G03G 21/18; G03G 21/16

(52) U.S. Cl. CPC G03G 21/1842; G03G 2221/1684; G03G 21/1619

(57) ABSTRACT

An image forming apparatus includes a development cartridge, a main body including an intermediate transfer belt, a tray to mount the development cartridge and to move between a drawing position drawn from the main body and a mounting position inserted into the main body, a support member to support the development cartridge, the support member supported by the tray and movable in a first direction toward the intermediate transfer belt and movable in a second direction opposite to the first direction, a support spring to apply an elastic force in the second direction to the support member, and a link member to move the support member in the first direction in correspondence with an operation of the tray being inserted from the drawing position toward the mounting position.

### BACKGROUND

An electrophotographic image forming apparatus may supply toner to an electrostatic latent image formed on a photoconductor, form a visible toner image on the photoconductor, transfer the toner image to a print medium, and fix the transferred toner image to the print medium to print an image on the print medium.

A development cartridge includes components for forming a visible toner image and is a consumable that may be replaced, such as at the end of its life. The development cartridge may be detachably attached to a main body of an image forming apparatus. The main body may be provided with a drawer member that may be drawn out from, and pushed into, the main body. The development cartridge may be mounted on the drawer member. The development cartridge may be mounted in the main body by drawing the drawer member from the main body, mounting the development cartridge on the drawer member, and pushing the drawer member into the main body. The development cartridge may be removed from the main body by drawing the drawer member mounted with the development cartridge from the main body and removing the development cartridge from the drawer member.

### BRIEF DESCRIPTION OF THE DRAWINGS

Various examples will be described below by referring to the following figures.

FIG. 1 is a schematic configuration diagram of an electrophotographic image forming apparatus according to an example;

FIG. 2 is a perspective view illustrating a method of mounting a development cartridge according to an example;

FIG. 3 is a perspective view of a sliding structure of a tray according to an example;

FIG. 4 is a side view illustrating a state in which a development cartridge is located at a second position before a tray reaches a mounting position according to an example;

FIG. 5 is a side view illustrating a state in which a tray reaches a mounting position and a development cartridge is located at a first position according to an example;

FIG. 6 is a perspective view of a coupling structure of a support member and a tray, illustrating a state in which a development cartridge is located at a second position according to an example;

FIG. 7 is a perspective view of a coupling structure of a support member and a tray, illustrating a state in which a development cartridge is located at a first position according to an example;

FIG. 8 is a diagram illustrating a combination of a development cartridge, a support member, and a link member according to an example; and

FIG. 9 is a side view illustrating a state in which a development cartridge is located at a second position before a tray reaches a mounting position according to an example.

### DETAILED DESCRIPTION OF EXAMPLES

Hereinafter, examples will be described with reference to the accompanying drawings. In the specification and drawings, like reference numerals may denote like elements having substantially the same functions and configurations, and thus redundant descriptions thereof may be omitted for conciseness.

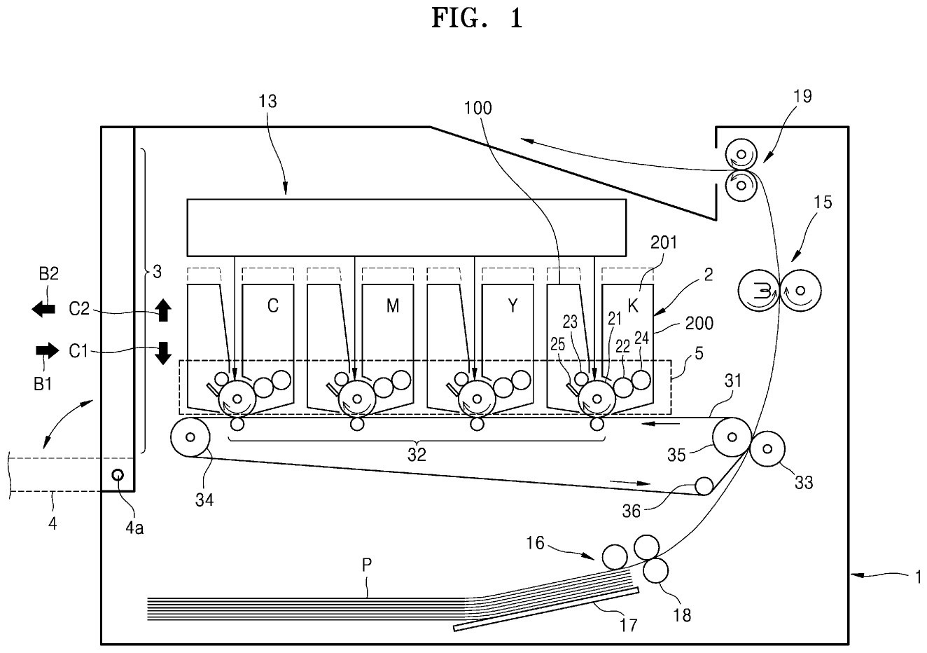

FIG. 1 is a schematic configuration diagram of an electrophotographic image forming apparatus according to an example.

Referring to FIG. 1, an image forming apparatus may include a main body 1, a plurality of development cartridges 2, an exposure unit 13, a transfer unit, and a fixing unit 15. In an example, the image forming apparatus may print a color image on a print medium P by an electrophotographic method.

For color printing, the plurality of development cartridges 2 may include four development cartridges 2 for developing images of, for example, cyan (C), magenta (M), yellow (Y), and black (K) colors. Hereinafter, an image forming apparatus including four development cartridges 2 will be described, and when C, M, Y, and K are added to reference numerals, they will refer to components for developing images of cyan (C), magenta (M), yellow (Y), and black (K) colors, respectively, unless otherwise specified.

The main body 1 may be provided with an opening 3 for providing a path through which the development cartridge 2 is mounted/removed. A door 4 may open/close the opening 3. The door 4 may be pivoted on a hinge 4a to open/close the opening 3. The main body 1 may be provided with the exposure unit 13, the transfer unit, and the fixing unit 15. Also, the main body 1 may be provided with a print medium transport unit for loading and transporting the print medium P on which an image is to be formed.

The development cartridge 2 may be an integrated development cartridge. The development cartridge 2 may include a photosensitive unit 100 and a developing unit 200.

The photosensitive unit 100 may include a photosensitive drum 21. As an example of a photoconductor on the surface of which an electrostatic latent image may be formed, the photosensitive drum 21 may include a conductive metal pipe and a photosensitive layer formed at the outer circumference thereof. A charging roller 23 may be an example of a charger for charging the photosensitive drum 21 to have a uniform surface potential. A cleaning blade 25 may be an example of a cleaning unit for removing toner or impurities remaining on the surface of the photosensitive drum 21 after an image transfer process described below.

The developing unit 200 may include a toner container 201. The developing unit 200 may supply toner contained in the toner container 201 to the electrostatic latent image formed on the photosensitive drum 21, to develop the electrostatic latent image into a visible toner image. The developing unit 200 may use a one-component developing method. A developing roller 22 may supply toner to the photosensitive drum 21. A developing bias voltage for supplying the toner to the photosensitive drum 21 may be applied to the developing roller 22. A supply roller 24 may supply toner in the toner container 201 to the surface of the developing roller 22. For this, a supply bias voltage may be applied to the supply roller 24. The developing unit 200 may further include a regulating member (not illustrated) for regulating the amount of toner supplied to a development nip, at which the photosensitive drum 21 and the developing roller 22 contact each other, by the developing roller 22.

The exposure unit 13 may irradiate light modulated corresponding to image information to the photosensitive drum 21 to form an electrostatic latent image on the photosensitive drum 21. The exposure unit 13 may include, for example, a laser scanning unit (LSU) using a laser diode as a light source or a light emitting diode (LED) exposure unit using an LED as a light source.

The transfer unit may include an intermediate transfer belt 31, primary transfer rollers 32, and a secondary transfer roller 33. The intermediate transfer belt 31 may be circulated while being supported by support rollers 34, 35, and 36. Four primary transfer rollers 32 may be arranged at positions facing the photosensitive drums 21 of development cartridges 2C, 2M, 2Y, and 2K, with the intermediate transfer belt 31 therebetween. A primary transfer bias voltage for primarily transferring the toner image developed on the photosensitive drum 21 to the intermediate transfer belt 31 may be applied to the four primary transfer rollers 32. The secondary transfer roller 33 may be located to face the intermediate transfer belt 31. A secondary transfer bias voltage for transferring the toner image primarily transferred to the intermediate transfer belt 31 to the print medium P may be applied to the secondary transfer roller 33.

The print medium P loaded on a loading table 17 may be drawn one by one by a pickup roller 16 and may be transported by a feed roller 18 to a transfer nip formed by the secondary transfer roller 33 and the intermediate transfer belt 31. The toner images primarily transferred onto the intermediate transfer belt 31 may be secondarily transferred to the print medium P by the secondary transfer bias voltage applied to the secondary transfer roller 33. When the print medium P passes through the fixing unit 15, the toner images may be fixed to the print medium P by heat and pressure. Upon completion of the fixing, the print medium P may be discharged outside by a discharge roller 19.

The development cartridges 2C, 2M, 2Y, and 2K may be detachably attached to the main body 1 through the opening 3 opened by the door 4.

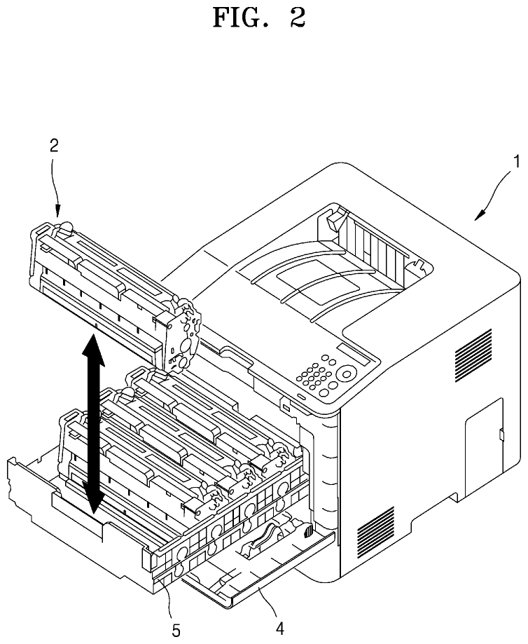

FIG. 2 is a perspective view illustrating a method of mounting a development cartridge according to an example.

Referring to FIGS. 1 and 2, a tray 5 is movable between a drawing or drawn out position (see FIG. 2), in which the tray 5 is drawn from the main body 1 while mounting the development cartridges 2C, 2M, 2Y, and 2K, and a mounting position (see FIG. 1), in which the tray 5 is inserted into the main body 1. For example, the door 4 may be opened and the tray 5 may be slid in a drawing direction B2 to be located at the drawing position. In the drawing position, the development cartridges 2C, 2M, 2Y, and 2K may be mounted on or dismounted from the tray 5. The tray 5 may be slid in a mounting direction B1 to be located at the mounting position and the door 4 may be closed.

A structure may be provided for preventing damage to the photosensitive drum 21 and the intermediate transfer belt 31 due to contact between the photosensitive drum 21 and the intermediate transfer belt 31 in the process of sliding the tray 5 between the mounting position and the drawing position. As an example, the tray 5 may move between the mounting position and the drawing position in a state in which the photosensitive drum 21 is spaced apart from the intermediate transfer belt 31.

In the image transfer process, the photosensitive drum 21 may need to contact the intermediate transfer belt 31 when the tray 5 is located at the mounting position. In this regard, the tray 5 may be moved between a position spaced apart from the intermediate transfer belt 31 and a position approaching the intermediate transfer belt 31 in correspondence with the opening/closing operation of the door 4. For example, the tray 5 may slide in the mounting direction B1 to move to the mounting position. When the tray 5 is located at the mounting position and the door 4 is closed, the tray 5 may move in a downward direction C1 in correspondence with the closing operation of the door 4 such that the cartridge 2 approaches the intermediate transfer belt 31. In the mounting position, the photosensitive drum 21 may contact the intermediate transfer belt 31. When the door 4 is opened, the tray 5 may move in an upward direction C2 and thus the photosensitive drum 21 may be spaced apart from the intermediate transfer belt 31. In this state, the tray 5 may be slid to be drawn outside the main body 1 as illustrated in FIG. 2. However, in order to implement this structure, a complex link structure and a lifting structure for converting the opening/closing operation of the door 4 into the lifting operation of the tray 5 may be required. Also, because the combined weight of the tray 5 mounted with the development cartridge 2 is lifted during the opening/closing operation of the door 4, the opening/closing operation of the door 4 may not be smoothly performed.

An example image forming apparatus may move the development cartridge 2 between a first position (indicated by solid lines in FIG. 1) approaching the intermediate transfer belt 31 and a second position (indicated by dashed lines in FIG. 1) spaced apart from the intermediate transfer belt 31 in correspondence with the mounting/drawing operation of the tray 5. For example, although the tray 5 may not move in the downward direction C1 and the upward direction C2, the development cartridge 2 may move in the downward direction C1 and the upward direction C2 with respect to the tray 5 in correspondence with the mounting/drawing operation of the tray 5. Because the tray 5 may not move in the downward direction C1 and the upward direction C2, a link structure and a lifting structure for converting the opening/closing operation of the door 4 into the lifting operation of the tray 5 may be avoided, thus reducing costs and improving ease of manufacture and use. Also, because lifting of the tray 5 mounted with the development cartridge 2 during the opening/closing operation of the door 4 may be avoided, the opening/closing operation of the door 4 may be more smoothly performed.

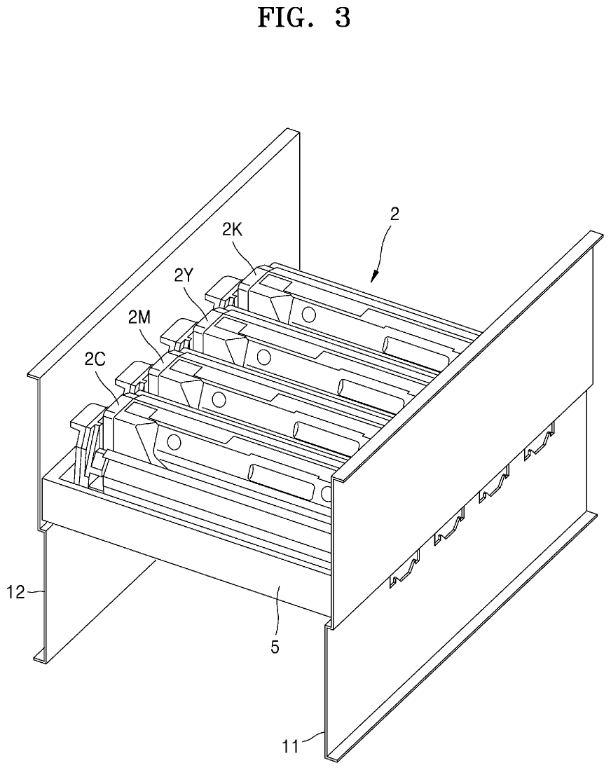

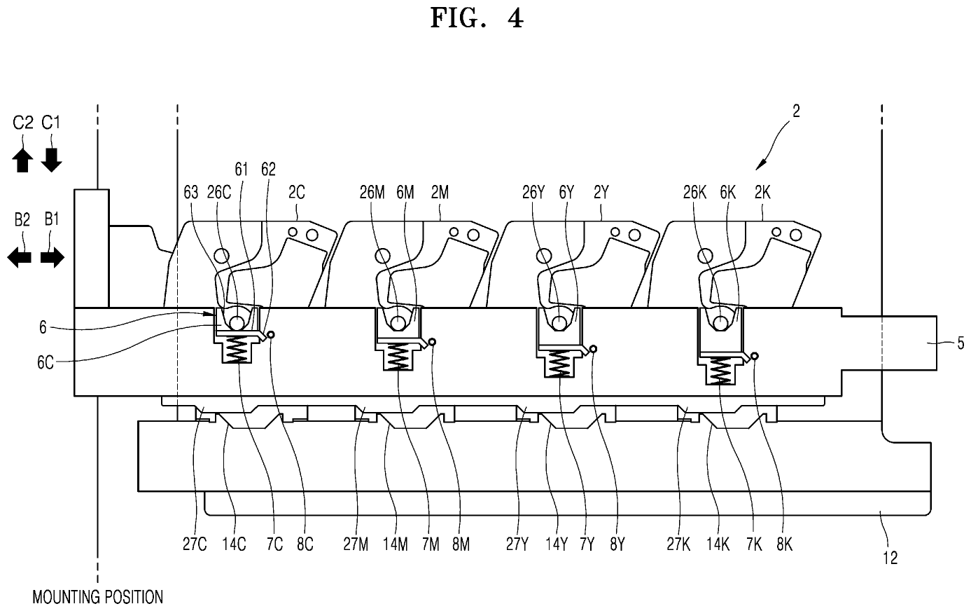

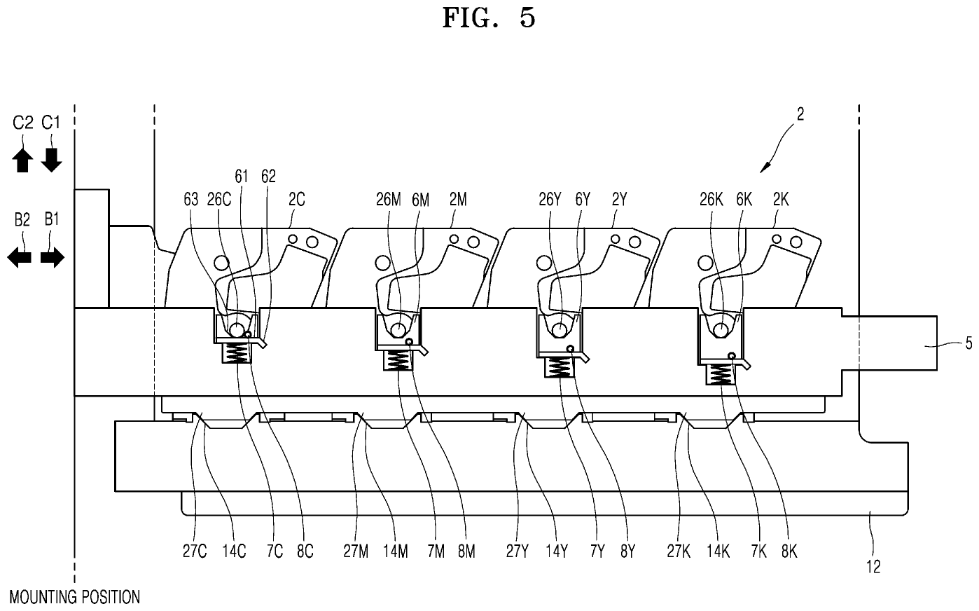

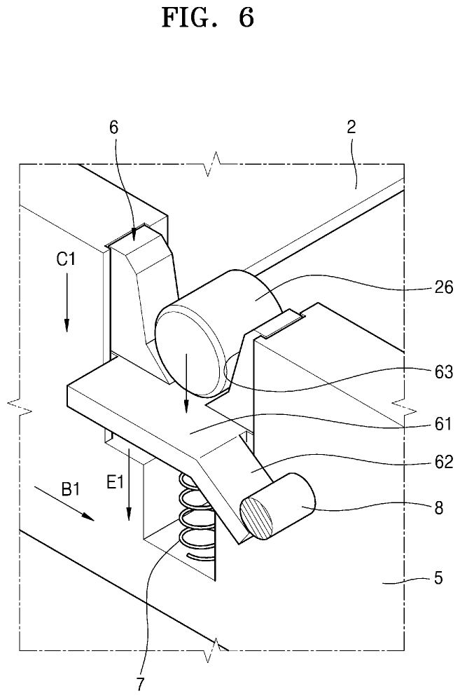

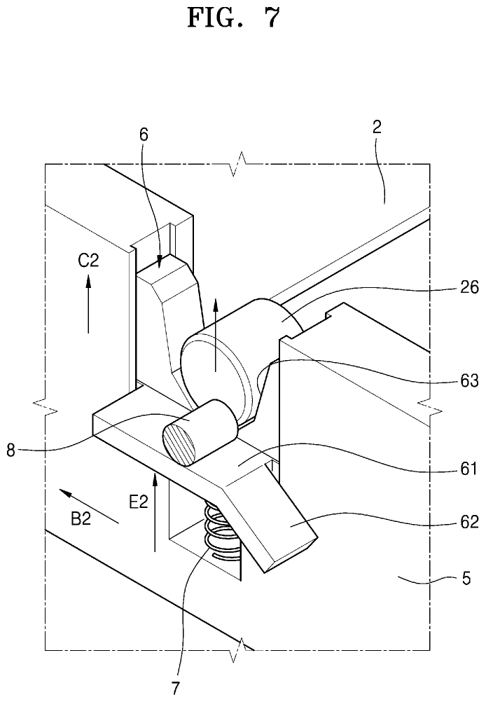

FIG. 3 is a perspective view of a sliding structure of a tray according to an example. FIG. 4 is a side view illustrating a state in which a development cartridge is located at a second position before a tray reaches a mounting position according to an example. FIG. 5 is a side view illustrating a state in which a tray reaches a mounting position and a development cartridge is located at a first position according to an example. FIG. 6 is a perspective view of a coupling structure of a support member and a tray, illustrating a state in which a development cartridge is located at a second position according to an example. FIG. 7 is a perspective view of a coupling structure of a support member and a tray, illustrating a state in which a development cartridge is located at a first position according to an example.

Referring to FIGS. 1 to 7, an image forming apparatus according to an example may include the development cartridge 2, the main body 1 including an intermediate transfer belt 31, the tray 5 to mount the development cartridge 2 and move between a drawing position (see FIG. 2) drawn from the main body 1 and a mounting position (see FIG. 1) inserted into the main body 1, a support member 6 to support the development cartridge 2, the support member 6 supported by the tray 5 and movable in a first direction E1 (see FIG. 6) toward the intermediate transfer belt 31 and in a second direction E2 (see FIG. 7) opposite to the first direction E1, a support spring 7 to apply an elastic force in the second direction E2 to the support member 6, and a link member 8 provided at the main body 1 to move the support member 6 in the first direction E1 in correspondence with an operation of the tray 5 being inserted from the drawing position to the mounting position.

When the support member 6 moves in the first direction E1, the development cartridge 2 may move from the second position (see FIG. 4) spaced apart from the intermediate transfer belt 31 to the first position (see FIG. 5) approaching the intermediate transfer belt 31. As an example, the first direction E1 and the second direction E2 may be respectively the downward direction C1 and the upward direction C2 described above.

The development cartridge 2 may include the photosensitive drum 21 on which an electrostatic latent image may be formed. At the second position, the photosensitive drum 21 may be spaced apart from the intermediate transfer belt 31, and at the first position, the photosensitive drum 21 may contact the intermediate transfer belt 31. The support spring 7 may apply, to the support member 6, an elastic force in the second direction E2, that is, an elastic force in a direction of locating the development cartridge 2 at the second position. The link member 8 may press the support member 6 in the first direction E1, that is, in an opposite direction of the elastic force of the support spring 7, to move the development cartridge 2 from the second position to the first position, in correspondence with an operation of the tray 5 being inserted from the drawing position into the mounting position.

Referring to FIG. 3, the development cartridge 2 may be mounted on the tray 5. The tray 5 may be supported by a pair of side brackets 11 and 12 located at both end portions in a widthwise direction to slide between the drawing position and the mounting position. The widthwise direction of the tray 5 may correspond to a lengthwise direction of the photosensitive drum 21. In the following description, the side bracket 11 is omitted in FIGS. 4 and 5 for sake of brevity and convenience.

Referring to FIG. 6, the tray 5 may be provided with the support member 6 for supporting the development cartridge 2 to be movable between the first and second positions. The support member 6 may be provided at both side portions of the tray 5. A support protrusion 26 may be provided at both side portions of the development cartridge 2. The support protrusion 26 may be supported by the support member 6. As an example, the support member 6 may include a support portion 63 where the support protrusion 26 may be seated. The support member 6 may include an extension portion 61 extending in the mounting direction B1 of the tray 5 and an inclination portion 62 inclining downward in the mounting direction B1 from the extension portion 61.

The support spring 7 may apply, to the support member 6, an elastic force in the second direction E2, that is, in the direction of locating the development cartridge 2 at the second position. For example, the support spring 7 may be implemented by a compression coil spring located between the support member 6 and the tray 5.

As the tray 5 approaches the mounting position, the link member 8 may interfere with the support member 6 to move the development cartridge 2 from the second position to the first position. The link member 8 may be provided at the pair of side brackets 11 and 12. For example, the link member 8 may be implemented by an interference protrusion protruding inward from the pair of side brackets 11 and 12.

When the development cartridge 2 is mounted on the tray 5 in a state where the tray 5 is located at the drawing position, the support protrusion 26 may be supported by the support member 6. By the elastic force of the support spring 7, the development cartridge 2 may be located at the second position where the photosensitive drum 21 is spaced apart from the intermediate transfer belt 31. The tray 5 may be slid in the mounting direction B1. Because the development cartridge 2 is located at the second position, interference of the photosensitive drum 21 with the intermediate transfer belt 31 may be reduced or prevented. When the tray 5 approaches the mounting position as illustrated in FIG. 4, the inclination portion 62 may approach the link member 8 provided at the main body 1 as illustrated in FIG. 6. In this state, when the tray 5 further slides in the mounting direction B1, the inclination portion 62 and the link member 8 may interfere with each other and the support member 6 may be pressed in an opposite direction of the elastic force of the support spring 7 to move in the first direction E1 and the development cartridge 2 may move in the downward direction C1 by gravity. When the tray 5 reaches the mounting position as illustrated in FIG. 7, the extension portion 61 may be supported by the link member 8. The development cartridge 2 may reach the first position as illustrated in FIG. 5.

When the link member 8 and the inclination portion 62 start to interfere with each other by sliding the tray 5 in the drawing direction B2 in the state illustrated in FIG. 7, the support member 6 may move in the second direction E2 by the elastic force of the support spring 7 and the development cartridge 2 may move in the upward direction C2. When the interference between the link member 8 and the inclination portion 62 terminates, the development cartridge 2 may reach the second position as illustrated in FIG. 6. In this state, the tray 5 may be drawn by pulling the tray 5 in the drawing direction B2.

In an example, the development cartridge 2 may be maintained at the second position until the tray 5 approaches the mounting position. Thus, because the interference between the photosensitive drum 21 and the intermediate transfer belt 31 does not occur while the tray 5 slides, damage to the photosensitive drum 21 and/or the intermediate transfer belt 31 may be reduced or prevented. Because the tray 5 slides only linearly, a guide structure for guiding the mounting/drawing operation of the tray 5 may be simplified and thus the reliability of the mounting/drawing operation of the tray 5 may be improved and the user may easily mount/draw the tray 5 due to the simple operation of the tray 5. Also, because the opening/closing operation of the door 4 and the lifting operation of the development cartridge 2 may not correspond to each other, no load may be applied when opening/closing the door 4 and thus the opening/closing operation of the door 4 may be smoothly implemented such that user convenience may be improved.

Referring to FIG. 4, the development cartridge 2 may include a plurality of development cartridges 2C, 2M, 2Y, and 2K arranged in the mounting direction B1. The support member 6 may include a plurality of support members 6C, 6M, 6Y, and 6K respectively supporting the development cartridges 2C, 2M, 2Y, and 2K. As an example, the plurality of support members 6C, 6M, 6Y, and 6K may be provided at both side portions of the tray 5. Support protrusions 26C, 26M, 26Y, and 26K may be provided at both side portions of the development cartridges 2C, 2M, 2Y, and 2K. The support protrusions 26C, 26M, 26Y, and 26K may be respectively supported by the support members 6C, 6M, 6Y, and 6K. The support spring 7 may include a plurality of support springs 7C, 7M, 7Y, and 7K respectively corresponding to the plurality of support members 6C, 6M, 6Y, and 6K. The support springs 7C, 7M, 7Y, and 7K may apply, to the support members 6C, 6M, 6Y, and 6K, an elastic force in the direction of locating the development cartridges 2C, 2M, 2Y, and 2K at the second position. For example, the support springs 7C, 7M, 7Y, and 7K may be implemented by compression coil springs located between the support members 6C, 6M, 6Y, and 6K and the tray 5. Each of the support members 6C, 6M, 6Y, and 6K may include an extension portion 61 and an inclination portion 62. The link member 8 may include a plurality of link members 8C, 8M, 8Y, and 8K respectively corresponding to the plurality of support members 6C, 6M, 6Y, and 6K.

The extension portion 61 and the inclination portion 62 of each of the support members 6C, 6M, 6Y, and 6K and the link members 8C, 8M, 8Y, and 8K may be provided such that, when the tray 5 slides in the mounting direction B1, elements corresponding to each other may interfere with each other and elements not corresponding to each other may not interfere with each other. For example, the link member 8K and the extension portion 61 and the inclination portion 62 of the support member 6K located toward the foremost side in the mounting direction B1 may be located toward a lowermost side (e.g., a first level), and the link member 8C and the extension portion 61 and the inclination portion 62 of the support member 6C located toward the rearmost side in the mounting direction B1 may be located toward an uppermost side (e.g., a fourth level). Also, the extension portion 61 and the inclination portion 62 of each of the support members 6C, 6M, 6Y, and 6K and the link members 8C, 8M, 8Y, and 8K may be provided such that they may simultaneously interfere with each other when the tray 5 approaches the mounting position.

When the development cartridges 2C, 2M, 2Y, and 2K are mounted on the tray 5 in a state where the tray 5 is located at the drawing position, the support protrusions 26C, 26M, 26Y, and 26K of the development cartridges 2C, 2M, 2Y, and 2K may be supported by the support members 6C, 6M, 6Y, and 6K. By the elastic force of the support springs 7C, 7M, 7Y, and 7K, the development cartridges 2C, 2M, 2Y, and 2K may be maintained at the second position where the photosensitive drum 21 is spaced apart from the intermediate transfer belt 31 and the tray 5 may be slid in the mounting direction B1. Because the development cartridges 2C, 2M, 2Y, and 2K are located at the second position, interference of the photosensitive drum 21 with the intermediate transfer belt 31 may be reduced or prevented.

As illustrated in FIG. 4, the development cartridges 2C, 2M, 2Y, and 2K may be maintained at the second position while the tray 5 slides from the drawing position to approach the mounting position. When the tray 5 further slides in the mounting direction B1, the inclination portion 62 of each of the support members 6C, 6M, 6Y, and 6K and the link members 8C, 8M, 8Y, and 8K may interfere with each other. The support members 6C, 6M, 6Y, and 6K may be pressed in opposite directions of the elastic force of the support springs 7C, 7M, 7Y, and 7K, and the development cartridges 2C, 2M, 2Y, and 2K may move in the downward direction C1 by gravity. When the tray 5 reaches the mounting position as illustrated in FIG. 5, the extension portion 61 of each of the support members 6C, 6M, 6Y, and 6K may be supported by the link members 8C, 8M, 8Y, and 8K and the development cartridges 2C, 2M, 2Y, and 2K may reach the first position.

When the link members 8C, 8M, 8Y, and 8K and the inclination portion 62 of each of the support members 6C, 6M, 6Y, and 6K start to interfere with each other by sliding the tray 5 in the drawing direction B2 in the state illustrated in FIG. 5, the support members 6C, 6M, 6Y, and 6K may be lifted up by the elastic force of the support springs 7C, 7M, 7Y, and 7K and the development cartridges 2C, 2M, 2Y, and 2K may move in the upward direction C2. When the interference between the link members 8C, 8M, 8Y, and 8K and the inclination portion 62 of each of the support members 6C, 6M, 6Y, 6K terminates, the development cartridges 2C, 2M, 2Y, and 2K may reach the second position as illustrated in FIG. 4. In this state, the tray 5 may be moved to the drawing position by sliding the tray 5 in the drawing direction B2.

Referring to FIGS. 4 and 5, the image forming apparatus may include a stopper for blocking the development cartridges 2C, 2M, 2Y, and 2K from exceeding the first position when the support members 6C, 6M, 6Y, and 6K move in the first direction E1. The stopper may include, for example, first stoppers 14C, 14M, 14Y, and 14K provided at the pair of side brackets 11 and 12 and second stoppers 27C, 27M, 27Y, and 27K provided at the development cartridges 2C, 2M, 2Y, and 2K to be supported by the first stoppers 14C, 14M, 14Y, and 14K at the first position.

The stopper may function as a position determining member for determining the positions of the development cartridges 2C, 2M, 2Y, and 2K in the main body 1. For this, the first stoppers 14C, 14M, 14Y, and 14K and the second stoppers 27C, 27M, 27Y, and 27K may have shapes to engage with each other. Accordingly, the positional accuracy and stability of the photosensitive drum 21 in the main body 1 may be improved.

In the above example, the link members 8C, 8M, 8Y, and 8K and the support members 6C, 6M, 6Y, and 6K respectively corresponding to the development cartridges 2C, 2M, 2Y, and 2K are used. However, other combinations thereof may also be possible.

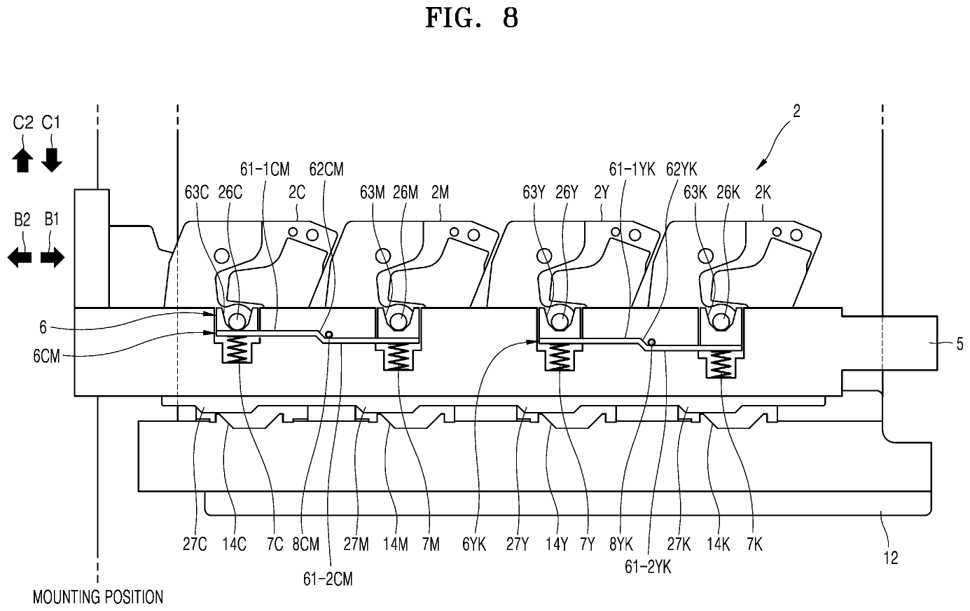

FIG. 8 is a diagram illustrating a combination of a development cartridge, a support member, and a link member according to an example.

Referring to FIG. 8, the support member 6 may include, for example, a first support member 6CM corresponding to two adjacent development cartridges (e.g., first and second development cartridges) 2C and 2M adjacent to each other and a second support member 6YK corresponding to two adjacent development cartridges (e.g., third and fourth development cartridges) 2Y and 2K.

The first support member 6CM may include first and second support portions 63C and 63M where the support protrusions 26C and 26M of the development cartridges 2C and 2M are respectively seated, a first inclination portion 62CM inclining downward in the mounting direction B1, and first and second extension portions 61-1CM and 61-2CM respectively connecting the first inclination portion 62CM to the first and second support portions 63C and 63M and extending in the mounting direction B1. The first inclination portion 62CM may be located between the first and second support portions 63C and 63M in the mounting direction B1. The first and second extension portions 61-1CM and 61-2CM may be located stepwise with the first inclination portion 62CM as a boundary therebetween. The second extension portion 61-2CM located toward a foreside in the mounting direction B1 may be located below (e.g., at a lower level than) the first extension portion 61-1CM located toward a rear side in the mounting direction B1. The second extension portion 61-2CM may avoid interference with a first link member 8CM corresponding thereto, which will be described below.

The second support member 6YK may include third and fourth support portions 63Y and 63K where the support protrusions 26Y and 26K of the development cartridges 2Y and 2K are respectively seated, a second inclination portion 62YK inclining downward in the mounting direction B1, and third and fourth extension portions 61-1YK and 61-2YK respectively connecting the second inclination portion 62YK to the third and fourth support portions 63Y and 63K and extending in the mounting direction B1. The second inclination portion 62YK may be located between the third and fourth support portions 63Y and 63K in the mounting direction B1. The third and fourth extension portions 61-1YK and 61-2YK may be located stepwise with the second inclination portion 62YK as a boundary therebetween. The fourth extension portion 61-2YK located toward a foreside in the mounting direction B1 may be located below (e.g., at a lower level than) the third extension portion 61-1YK located toward a rear side in the mounting direction B1. The fourth extension portion 61-2YK may avoid interference with a second link member 8YK corresponding thereto, which will be described below.

The link member 8 may include first and second link members 8CM and 8YK respectively corresponding to the first and second support members 6CM and 6YK. The second support member 6YK located toward a foreside in the mounting direction B1 may be located to avoid interference with the first link member 8CM located toward a rear side in the mounting direction B1. Although not illustrated, the support springs 7C and 7M may elastically support the first support member 6CM, and the support springs 7Y and 7K may elastically support the second support member 6YK.

When the tray 5 slides to the mounting position, the first link member 8CM may interfere with the first and second extension portions 61-1CM and 61-2CM and the first inclination portion 62CM of the first support member 6CM and the second link member 8YK may interfere with the third and fourth extension portions 61-1YK and 61-2YK and the second inclination portion 62YK of the second support member 6YK to move the development cartridges 2C, 2M, 2Y, and 2K from the second position to the first position. When the tray 5 is located at the mounting position, the first and second link members 8CM and 8YK may be respectively supported by the first extension portion 61-1CM and the third extension portion 61-1YK.

According to this example, the number of components may be reduced and thus the component cost and the assembly cost may be reduced. Also, because the first link member 8CM is supported by the first extension portion 61-1CM between the first and second support portions 63C and 63M and the second link member 8YK is supported by the third extension portion 61-1YK between the third and fourth support portions 63Y and 63K, the development cartridges 2C, 2M, 2Y, and 2K may stably move to the first position without inclination.

In the above example, a structure in which the development cartridge 2 may move from the second position to the first position by the interference between the link member 8 and the support member 6 is used; however, other structures thereof may also be possible. As an example, the link member 8 may be configured to move the development cartridge 2 from the second position to the first position by pressing the development cartridge 2 in an opposite direction of the elastic force of the support spring 7. In this case, the support member 6 may not need to include the extension portion 61 and the inclination portion 62.

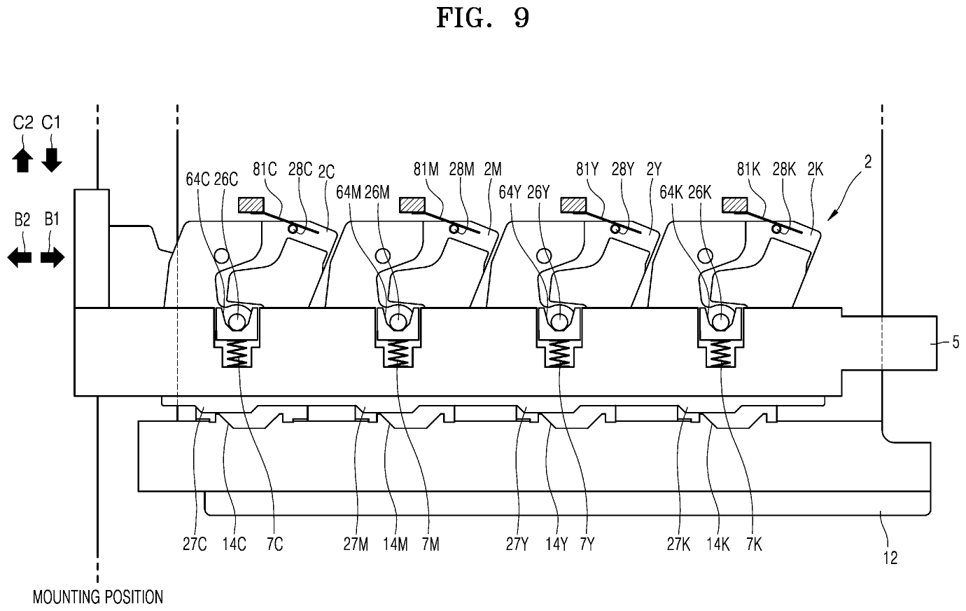

FIG. 9 is a side view illustrating a state in which a development cartridge is located at a second position before a tray reaches a mounting position according to an example.

Referring to FIG. 9, the tray 5 may be provided with support members 64C, 64M, 64Y, and 64K for respectively supporting the development cartridges 2C, 2M, 2Y, and 2K. The support members 64C, 64M, 64Y, and 64K may differ from the support members 6C, 6M, 6Y, and 6K in that the extension portion 61 and the inclination portion 62 are not provided. The support springs 7C, 7M, 7Y, and 7K may apply, to the support members 64C, 64M, 64Y, and 64K, an elastic force in the direction of locating the development cartridges 2C, 2M, 2Y, and 2K at the second position.

The development cartridges 2C, 2M, 2Y, and 2K may be provided with interference portions 28C, 28M, 28Y, and 28K. The interference portions 28C, 28M, 28Y, and 28K may protrude from both side portions of the development cartridges 2C, 2M, 2Y, and 2K. Link members 81C, 81M, 81Y, and 81K may respectively correspond to the interference portions 28C, 28M, 28Y, and 28K and may move the development cartridges 2C, 2M, 2Y, and 2K to the first position by pressing the interference portions 28C, 28M, 28Y, and 28K in an opposite direction of the elastic force of the support springs 7C, 7M, 7Y, and 7K as the tray 5 approaches the mounting position. The link members 81C, 81M, 81Y, and 81K may be provided, for example, at the pair of side brackets 11 and 12. The interference portions 28C, 28M, 28Y, and 28K may have different protrusion amounts such that the interference portions 28C, 28M, 28Y, and 28K may interfere only with the corresponding members among the link members 81C, 81M, 81Y, and 81K. For example, the interference portion 28K located toward the foremost side in the mounting direction B1 of the tray 5 may have the smallest protrusion amount and the interference portion 28C located toward the rearmost side in the mounting direction B1 of the tray 5 may have the largest protrusion amount. Also, the link member 81K may be located toward the innermost side in the widthwise direction and the link member 81C may be located toward the outermost side in the widthwise direction.

The link members 81C, 81M, 81Y, and 81K may include elastic members. For example, the link members 81C, 81M, 81Y, and 81K may be implemented by leaf springs. In this case, the magnitude of the elastic force of the link members 81C, 81M, 81Y, and 81K may be greater than the magnitude of the elastic force of the support springs 7C, 7M, 7Y, and 7K.

By this configuration, when the tray 5 reaches the mounting position, the link members 81C, 81M, 81Y, and 81K may move the development cartridges 2C, 2M, 2Y, and 2K from the second position to the first position by pressing the interference portions 28C, 28M, 28Y, and 28K in an opposite direction of the elastic force of the support springs 7C, 7M, 7Y, and 7K. Also, because the elastic force of the link members 81C, 81M, 81Y, and 81K is applied to the development cartridges 2C, 2M, 2Y, and 2K, the development cartridges 2C, 2M, 2Y, and 2K may be stably maintained at the first position. Also, according to the structure in which the second stoppers 27C, 27M, 27Y, and 27K provided at the development cartridges 2C, 2M, 2Y, and 2K are supported at the first position by the first stoppers 14C, 14M, 14Y, and 14K provided at the pair of side brackets 11 and 12, the positional stability of the development cartridges 2C, 2M, 2Y, and 2K may be further improved.

The structure illustrated in FIG. 9 may also be additionally applied to the structure illustrated in FIGS. 3 to 8 in which the development cartridge 2 moves from the second position to the first position by the interference between the link member 8 and the support member 6. Accordingly, the development cartridge 2 may be stably maintained at the first position.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. An image forming apparatus comprising:
a development cartridge;
a main body including an intermediate transfer belt;
a tray to mount the development cartridge and move between a drawing position drawn from the main body and a mounting position inserted into the main body;
a support member to support the development cartridge, the support member supported by the tray and movable in a first direction toward the intermediate transfer belt and movable in a second direction opposite to the first direction;
a support spring to apply an elastic force in the second direction to the support member; and
a link member to move the support member in the first direction in correspondence with an operation of the tray being inserted from the drawing position toward the mounting position.

2. The image forming apparatus of claim 1,
wherein the support member is provided at two side portions of the tray, and
wherein the development cartridge comprises a support protrusion, supported by the support member, provided at two side portions of the development cartridge.

3. The image forming apparatus of claim 1, wherein the link member, as the tray approaches the mounting position, is to press the support member in the first direction to move the development cartridge between a second position, spaced apart from the intermediate transfer belt, and a first position, approaching the intermediate transfer belt.

4. The image forming apparatus of claim 3, wherein the link member, as the tray moves from the mounting position toward the drawing position, is spaced apart from the support member to allow the development cartridge to return to the second position.

5. The image forming apparatus of claim 3,
wherein the support member comprises an extension portion extending in a mounting direction of the tray and an inclination portion inclining downward in the mounting direction from the extension portion, and
wherein the link member interferes with the inclination portion as the tray approaches the mounting position and is supported by the extension portion when the tray reaches the mounting position.

6. The image forming apparatus of claim 3,
wherein the development cartridge comprises first, second, third, and fourth development cartridges arranged in a mounting direction,
wherein the support member comprises a first support member to support the first and second development cartridges and a second support member to support the third and fourth development cartridges, and
wherein the link member comprises first and second link members respectively corresponding to the first and second support members.

7. The image forming apparatus of claim 6,
wherein the first support member comprises a first support portion and a second support portion respectively supporting support protrusions of the first and second development cartridges, a first inclination portion inclining downward in the mounting direction, and a first extension portion and a second extension portion respectively connecting the first inclination portion to the first support portion and the second support portion, and
wherein the second support member comprises a third support portion and a fourth support portion respectively supporting support protrusions of the third and fourth development cartridges, a second inclination portion inclining downward in the mounting direction, and a third extension portion and a fourth extension portion respectively connecting the second inclination portion to the third support portion and the fourth support portion.

8. The image forming apparatus of claim 7,
wherein the first inclination portion is located between the first support portion and the second support portion, and
wherein the second inclination portion is located between the third support portion and the fourth support portion.

9. The image forming apparatus of claim 6, wherein the second support member is located toward a foreside in the mounting direction to prevent interference with the first link member that is located toward a rear side in the mounting direction.

10. The image forming apparatus of claim 2,
wherein an interference portion is provided at the development cartridge, and
wherein the link member, as the tray approaches the mounting position, is to press the interference portion in an opposite direction of the elastic force of the support spring to move the development cartridge from a second position spaced apart from the intermediate transfer belt to a first position approaching the intermediate transfer belt.

11. The image forming apparatus of claim 2, further comprising a stopper to block the development cartridge from exceeding a first position approaching the intermediate transfer belt, when the support member moves in the first direction.

12. An image forming apparatus comprising:
a development cartridge comprising a photosensitive drum;
a main body comprising an intermediate transfer belt;
a tray to mount the development cartridge and move between a drawing position drawn from the main body and a mounting position inserted into the main body;
a support member to support the development cartridge and movably supported by the tray such that the development cartridge is movable between a first position where the photosensitive drum contacts the intermediate transfer belt and a second position where the photosensitive drum is spaced apart from the intermediate transfer belt;
a support spring to apply, to the support member, an elastic force in a direction of locating the development cartridge at the second position; and
a link member to press the support member in an opposite direction of the elastic force of the support spring to move the development cartridge from the second position to the first position in correspondence with an operation of the tray being inserted from the drawing position to the mounting position.

13. The image forming apparatus of claim 12,
wherein the support member comprises an extension portion extending in a mounting direction of the tray and an inclination portion inclining downward in the mounting direction from the extension portion, and
wherein the link member interferes with the inclination portion as the tray approaches the mounting position and is supported by the extension portion when the tray reaches the mounting position.

14. The image forming apparatus of claim 13, further comprising a stopper to block the development cartridge from exceeding the first position.

15. The image forming apparatus of claim 12,
wherein an interference portion is provided at the development cartridge, and
wherein the link member is to press the interference portion in an opposite direction of the elastic force of the support spring when the tray reaches the mounting position.
